(19) United States
(12) Patent Application Publication
(10) Pub. No.: US 2005/0040967 A1
(43) Pub. Date: Feb. 24, 2005

(54) System for remotely communicating with domestic appliances

(75) Inventors: Jurgen Taag, Wangen (DE); Konrad Schaller, Wangen (DE); Bernd Theobold, Wangen (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 10/911,950

(22) Filed: Aug. 4, 2004

(30) Foreign Application Priority Data
Aug. 8, 2003 (DE) 103 36 559.1

(51) Int. Cl. H04Q 1/00

(52) U.S. Cl. 340/825

(57) ABSTRACT

A flexible, linked system which can be implemented at low cost for remotely communicating with domestic appliances with their large number of appliance-specific interfaces is afforded if the domestic appliances are connected to a house central station which is equipped with basic software for interrogating the identification of the domestic appliances. By way of the ascertained identification, the house central station obtains from a database the bus access software required for access to the appliance-specific interface and stores it and thus permits communication by way of the appliance-specific interface of the respective appliance.

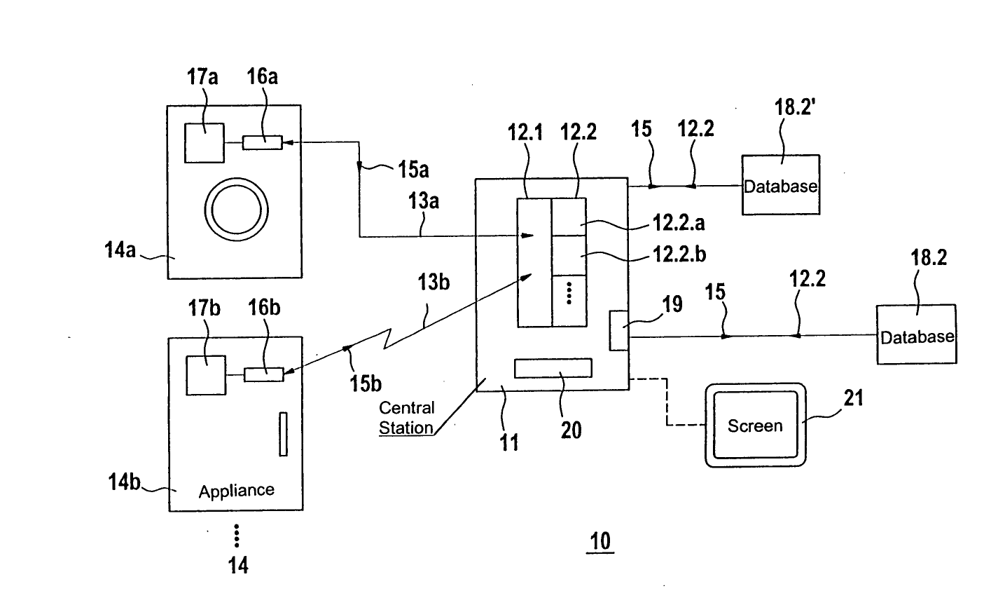

### BACKGROUND OF THE INVENTION

### FIELD OF THE INVENTION

The invention concerns a system for remotely communicating with domestic appliances having appliance-specific interface protocols.

A system of this general kind is set forth in Published, Non-Prosecuted German Patent Application DE 101 26 816 A1 which describes a remote control and remote inquiry of domestic appliances. By way of the use of matching networks between the interface in relation to the appliance bus of the domestic appliance and the communication network, that system affords the possibility of switching over between various communication protocols. In that way it is then possible for example by way of a house central station which is set up for the DECT standard also to communicate with domestic appliances which do not communicate on the DECT standard as they can be switched over to the DECT standard for the communication by way of the matching network which is to be found at the appliance bus interface. With the large number of appliances and manufacturers and the accompanying wide range of different electronic control systems however the complication and expenditure in equipping each appliance with a matching network for communication purposes is significant and costly. In addition it is, at the present time, not yet possible to foresee which communication protocols will gain in significance in the future. On the other hand the communication protocols for remote signaling connections are severely limited and therefore at the present time and indeed also for the future are little suited for rapidly affording graphic operational support.

### SUMMARY OF THE INVENTION

It is accordingly an object of the invention to provide a system for remotely communicating with domestic appliances which overcomes the above-mentioned disadvantages of the prior art devices of this general type, which at a low cost permits and promotes remote communication with domestic appliances from various manufacturers which have firm-specific and thus differing configurations in respect of their appliance bus interface protocols.

With the foregoing and other objects in view there is provided, in accordance with the invention, a system for remotely communicating with domestic appliances having different interface protocols. The system contains a database and a house central station connected to the database and having basic software for ascertaining identification of a domestic appliance just being addressed. The house central station with knowledge of the identification of the domestic appliance obtains corresponding appliance-specific bus access software of the domestic appliance from the database and stores the appliance-specific bus access software.

The house central station can communicate with each domestic appliance directly by way of its appliance-specific interface. The house central station is equipped with basic software for appliance identification and interrogates the identification of the domestic appliance just being addressed. By that identification which can involve a number or a combination of letters and numbers, the house central station obtains from a database the appliance software associated with the appliance and stores it. In that way a communication can now be made between the house central station and the domestic appliance directly by way of the interface protocol of the appliance, and the bottleneck by way of an interposed communication protocol is removed.

If, in the case of a rare electronic control system of an appliance which for example is no longer normally commercially available, the house central station does not have the necessary basic software for identification purposes, it is possible to provide for manual presetting for identification purposes at the house central station.

The interface at the domestic appliance, which the basic software accesses, can involve a conventional interface for testing and checking the appliance or an interface equipped especially with a protocol for the remote communication.

A version of the system is particularly convenient, in which the house central station can have access by way of an Internet connection to an external database for downloading the communication software ascertained by way of the identification of the domestic appliance. Alternatively it is also possible for the firm-specific communication software to be fed in from a local database, for example by way of a CD or a floppy disk.

Other features which are considered as characteristic for the invention are set forth in the appended claims.

Although the invention is illustrated and described herein as embodied in a system for remotely communicating with domestic appliances, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is an abstracted block circuit diagram of structure of a domestic network containing a house central station and domestic appliances linked thereto with different manufacturer-specific appliance buses.

### DESCRIPTION OF THE PREFERRED EMBODIMENTS

Referring now to the single FIGURE of the drawing in detail, there is shown a communication system 10 having a house central station 11 containing basic software 12.1. By use of the basic software 12.1, the central station 11 can make contact by way of a connection 13a, 13b with a domestic appliance 14a, 14b for ascertaining the identification 15a, 15b thereof, by way of its interface 16a, 16b. In that respect the connection can be made either by way of a cable 13a, such as for example a network line, or by way of a wireless transmission section 13b, such as for example by way of infrared or radio transmission. Each domestic appliance 14a, 14b has an appliance-specific interface 16a, 16b and an appliance-specific electronic control 17a, 17b for, for example, display and operation purposes. The interface 16a, 16b can have a protocol which is originally predetermined for testing and checking purposes while in the case of modern appliances and in future, the complete protocol of the internal appliance bus is available by way of the interface 16a, 16b in order to be able to intervene in the operating procedure by way of remote-action methodology and to interrogate the operating situation.

By use of the basic software 12.1, the central station 11 can interrogate the identity of the washing machine 14a by way of the connection 13a and then, from a database 18.2, 18.2′, specifying that identification 15a, download the bus access software 12.2a which is required for comprehensive communication with the appliance 14a, going beyond mere establishment of identity, and store it in its memory. The bus access software 12.2a is the appliance-specific interface protocol for the comprehensive communication with the washing machine 14a. The central station 11 can have an Internet connection 19 in order to obtain the bus access software 12.2 from an external database 18.2; or the bus access software 12.2 is interrogated from a local database 18.2′ which is to be found on a data carrier such as a floppy disk or a CD which is read out directly by the central station 11 or by way of a peripheral unit.

If a plurality of appliances 14a, 14b operate with identical bus protocols because for example they originate from the same manufacturer or for other reasons are in accordance with the same standard, those appliances may also have only one common connection 13a, 13b to the central station 11, in a condition of being connected together.

The central station 11 also obtains the bus access software 12.2 that is required for communication with the refrigerator 14b and further appliances 14 which are networked to the central station 11, in the above-described manner. If the identification 15 of an appliance 14 that, for example is not commercially usual, cannot be interrogated by way of the basic software 12.1 of the central station 11, then it is possible to preset the specific identification 15 to the central station 11 by way of an internal or external keyboard 20.

It is further possible to plan that a representation of the graphical user interface and optionally also operation of the domestic appliance 14 by way of screen 21 connected to the central station 11 is possible by way of the appliance-specific bus access software 12.1. In that way the screen 21 can display the predetermined program and the part that at the present time is just being processed therefrom. If the screen 21 is equipped with an input device such as switches or touch-sensitive regions, manual operation of the appliance 14 can then be effected by way of the screen 21, just as if the appliance 14 were being operated directly. The screen 21 may be for example a monitor, a web panel, a cellular phone display or a comparable device. The connection thereof to the central station 11 is effected by wire or wirelessly by way of a communication system such as the Internet, as indicated generally symbolically in the drawing by a broken-line connection.

A flexible, linked system 10 which can be implemented at low cost for remotely communicating with domestic appliances 14 with their large number of appliance-specific interfaces 16 is afforded if the domestic appliances 14 are connected to the house central station 11 which is downloaded with basic software 12.1 for interrogating the identification 15 of the domestic appliances 14 and by way of the ascertained identification 15 obtains from a database 18 the bus access software 12.2 required for access to the appliance-specific interface 16a, 16b and stores it and thus permits communication by way of the appliance-specific interface 16 of the respective appliance 14.

This application claims the priority, under 35 U.S.C. § 119, of German patent application No. 103 36 559.1, filed Aug. 8, 2003; the entire disclosure of the prior application is herewith incorporated by reference.

1. A system for remotely communicating with domestic appliances having different interface protocols, the system comprising:
a database; and
a house central station connected to said database and having basic software for ascertaining identification of a domestic appliance just being addressed, said house central station with knowledge of the identification of the domestic appliance obtaining a corresponding appliance-specific bus access software of the domestic appliance from said database and storing the appliance-specific bus access software.

2. The system according to claim 1, wherein said house central station has an Internet connection for obtaining the appliance-specific bus access software from said database being an external database.

3. The system according to claim 1, wherein said house central station obtains the appliance-specific bus access software from said database being a locally provided database.

4. The system according to claim 1, further comprising a screen connected to said house central station, said house central station, with ascertainment of the appliance-specific bus access software, obtains information about representation of at least a part of appliance-specific operating and display functions of the domestic appliance for representation and optionally for operation on said screen.

5. The system according to claim 1, further comprising a cable connected between an interface of the domestic appliance and said house central station, communication between the interface of the domestic appliance and said house central station is effected by way of said cable.

6. The system according to claim 1, wherein communication between an interface of the domestic appliance and said house central station is effected wirelessly.

7. The system according to claim 5, wherein said cable is selected from the group consisting of electrical cables and optical cables.
